(19) United States
(12) Patent Application Publication
(10) Pub. No.: US 2018/0131314 A1
(43) Pub. Date: May 10, 2018

(54) ROOF MOUNTING SYSTEM

(71) Applicant: Rillito River Solar, LLC, Phoenix, AZ (US)

(72) Inventors: BRIAN CECIL STEARNS, TUCSON, AZ (US); ALEXANDER GRANT BORNEMANN, PHOENIX, AZ (US)

(21) Appl. No.: 15/701,378

(22) Filed: Sep. 11, 2017

Related U.S. Application Data
(60) Provisional application No. 62/393,565, filed on Sep. 12, 2016.

(51) Int. Cl. H02S 20/23; F16B 5/06; F16B 5/02; F16B 2/12

(52) U.S. Cl. CPC H02S 20/23; F16B 2/12; F16B 5/0233; F16B 5/0614

(57) ABSTRACT

In various embodiments, a roof mounting system may comprise a short base, a tall base, a first clamp assembly and a second clamp assembly. The short base may have a first body and a first slot. The first slot may be formed on the first body at an angle. The tall base may have a second body and a second slot. The second slot may be formed on the second body at the angle. The first clamp assembly may be configured to be operatively couple to the first slot. The second clamp assembly may be configured to be operatively couple to the second slot. The first clamp and the second clamp may be configured to engage and retain a solar panel on the short base and the tall base at the angle.

### CROSS REFERENCE TO RELATED APPLICATIONS

The present application claims priority to and the benefit of U.S. Provisional Patent Application Nos. 62/393,565, filed Sep. 12, 2016 and entitled ROOF MOUNT SYSTEM, the entire contents of which is herein incorporated by reference for any purpose.

### FIELD

The present disclosure relates to solar panel mounting systems and more specifically to mounting systems for flat roofs.

### SUMMARY

In various embodiments, a roof mounting system may comprise a short base, a tall base, a first clamp assembly and a second clamp assembly. The short base may have a first body and a first slot. The first slot may be formed on the first body at an angle. The tall base may have a second body and a second slot. The second slot may be formed on the second body at the angle. The first clamp assembly may be configured to be operatively couple to the first slot. The second clamp assembly may be configured to be operatively couple to the second slot. The first clamp and the second clamp may be configured to engage and retain a solar panel on the short base and the tall base at the angle.

In various embodiments, the support fastener may be installable in the first slot or the second slot. The support fastener may be configured to support the first clamp or the second clamp.

In various embodiments, the first clamp assembly may comprise a threaded shaft that are installable in the first slot. The first clamp assembly may include a level nut and a support plate. The level nut and support plate may be adjustably installable on the threaded shaft and configured to support a solar panel.

In various embodiments, the first clamp assembly and/or the second clamp assembly may comprise a spacer block that is configured to support a clamp. The spacer block may be installed with the first clamp assembly or the second clamp assembly where the first clamp assembly or the second clamp assembly supports the end of an array or is configured as an end clamp.

In various embodiments, each clamp assembly may comprise a clamp. Each clamp may comprise, include, or be configured with a pin or a tooth. The pin or tooth may be configured to create an electrically conductive path between the clamp and the solar panel. The clamp may be configured with the tooth where the clamp is made of stainless steel. The clamp may include the pin where the clamp is made of aluminum.

In various embodiments, the mounting system may comprise a spacer. The spacer may be configured to mount to at least one of the first slot and the second slot. The spacer may be used to provide additional height for the mounting system. In this regard, the spacer may be configured to mount a solar panel array over roof obstructions, such as, for example, vent pipes, chimneys, whirly birds, and/or the like.

In various embodiments, the second body of the tall base may include a cross support. The second body may also define a first hollow and a second hollow. The cross support may be disposed between the first hollow and the second hollow.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIGS. 1A-1D illustrate various perspective views of a mounting systems and components for a first attachment point, in accordance with various embodiments;

FIGS. 2A-2F illustrate various perspective views of a mounting systems and components for a second attachment point, in accordance with various embodiments;

FIG. 3 illustrates an exploded perspective view of a clamp and a portion of a mounting system, in accordance with various embodiments;

FIG. 4 illustrates an exploded perspective view of a spacer and a portion of a mounting system, in accordance with various embodiments;

FIGS. 5A-5D illustrate various perspective views of solar panels being installed with a mounting system, in accordance with various embodiments;

FIGS. 6A-6B illustrate side views of the installation angle of a solar panel that is installed with a mounting system, in accordance with various embodiments;

FIGS. 7A-7B illustrate side views of the installation angle of a solar panel that is installed with a mounting system, in accordance with various embodiments;

FIGS. 8A-8D illustrate views of a mounting system with height adjustment, in accordance with various embodiments; and

FIGS. 9A-9B illustrate views of a mounting system including hooks, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

In various embodiments, the roof mounting system may be configured for securing a solar panel array to a roof. More specifically, the system may be configured to mount solar panels to a flat roof (e.g., a concrete roof). The system may be configured to mount the panels at an angle about the roof surface. The system may include an integrated electrical bonding system that is compliant with the requirements of UL 2703, First Edition or any other similar specification related to solar panel racking and/or mounting hardware.

In various embodiments, the mounting systems described herein may be configured to mount a solar panel array to a flat concrete roof similar to those found throughout the Caribbean and Central and South America. The mounting system described herein may be configured as a rail-less flat roof mounting system. The mounting systems described herein may be secured to a flat roof using anchors that do not completely penetrate the roof surface.

In various embodiments, a roof mounting system may comprise a short base, a tall base, a first clamp assembly and a second clamp assembly. The short base may have a first body and a first slot. The first slot may be formed on the first body at an angle. The tall base may have a second body and a second slot. The second slot may be formed on the second body at the angle. The first clamp assembly may be configured to be operatively couple to the first slot. The second clamp assembly may be configured to be operatively couple to the second slot. The first clamp and the second clamp may be configured to engage and retain a solar panel on the short base and the tall base at the angle.

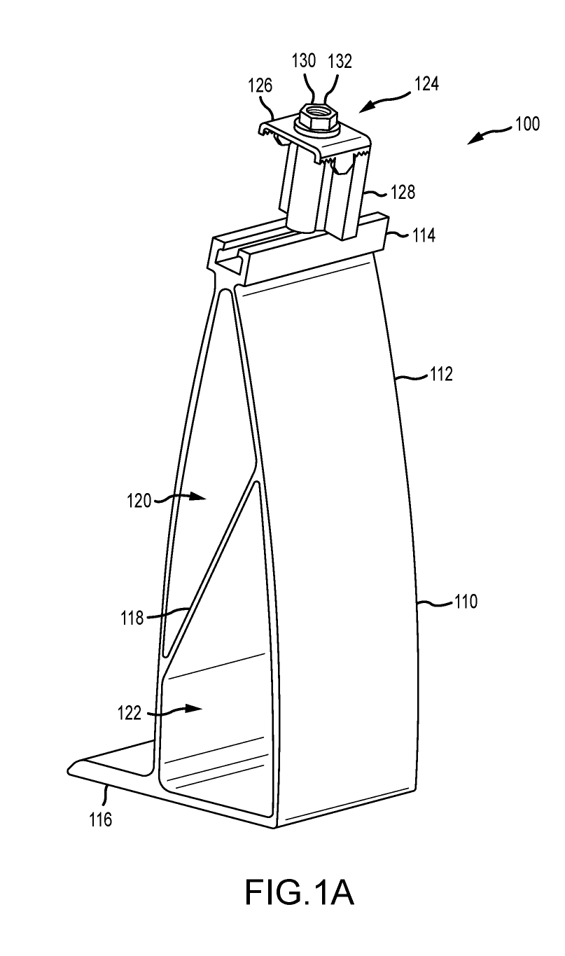

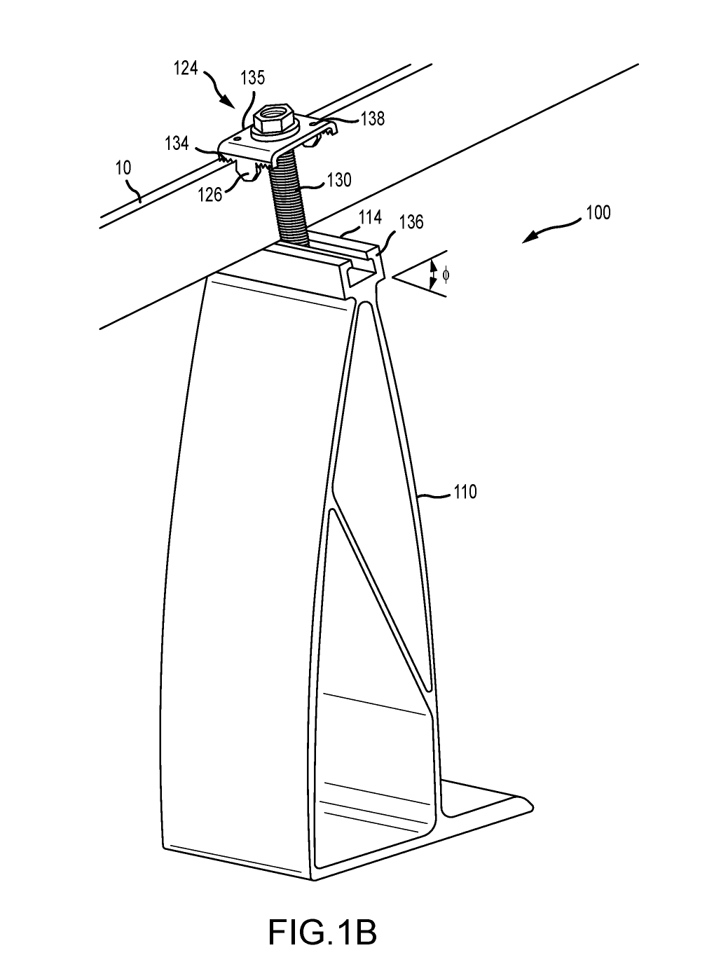

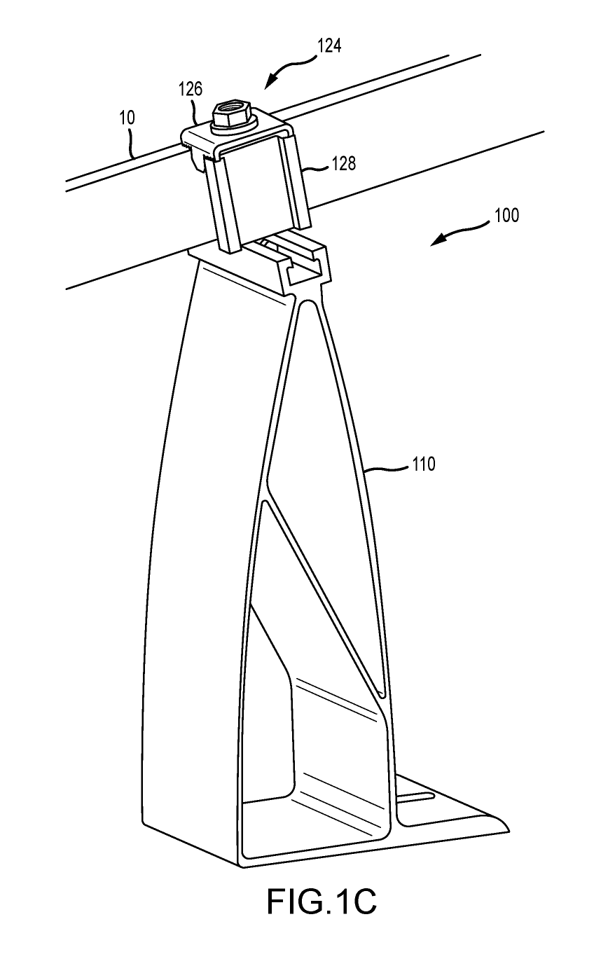

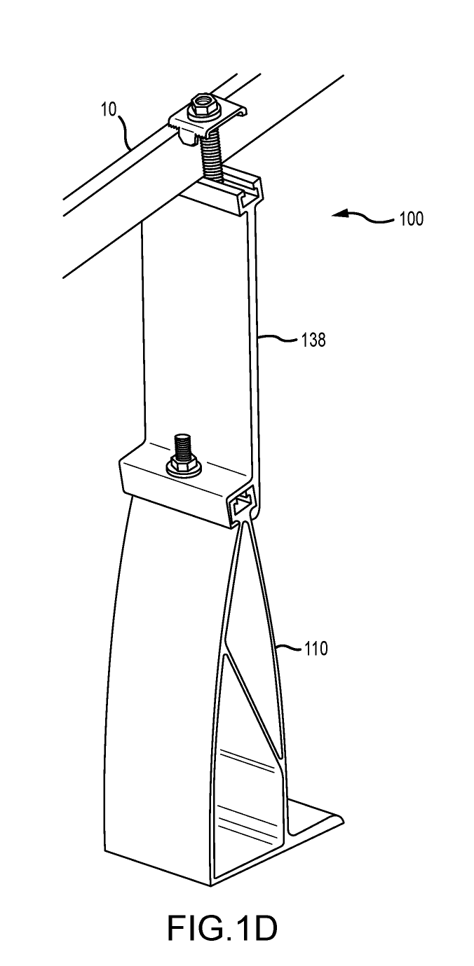

In various embodiments and with reference to FIGS. 1A-1D, solar panel support system 100 may be configured to attach a solar panel to a roof. System 100 may comprise a tall base 110. Tall base 110 may include a body 112, an attachment point 114, a foot 116, and a cross support 118. Attachment point 114 may be formed in or operatively coupled to the top of body 112. Foot 116 may be formed in or operatively coupled to the bottom for body 112. Cross support 118 may divide a hollow defined by body 112. In this regard, body 112 and cross support 118 may define a first hollow 120 and a second hollow 122. Cross support 118 may also be configured to strengthen body 112.

In various embodiments, system 100 may comprise clamp assembly 124. Clamp assembly 124 may be mounted to body 112 via attachment point 114. Clamp assembly 124 may comprise clamp 126, fastener 130 and nut 132. Clamp assembly 124 may also comprise a spacer block 128. Spacer block 128 may be optionally installed at the end of column of panels in an array. In this regard, spacer bock 128 may simulate the frame of a solar module so that clamp assembly 124 properly engages and retains the module at the end of the array. Spacer block 128 may be any suitable size. For example, spacer block 128 may be installable in two or more orientations. In this regard, spacer block 128 may be configured to provide various heights that replicate the various thicknesses of solar panel frames (e.g., 32 mm, 33 mm, 35, mm, 38 mm, 40 mm, 45 mm, 50 mm and/or any other suitable height).

In various embodiments, attachment point 114 may comprise one or more serrations 136. Fastener 130 may be configured to contact and/or deform a portion of serration 136. In this regard, fastener 130 may create an electrically conductive path (e.g., a bond path as required by UL 2703 or a similar standard). between attachment point 114—tall base 110. Moreover, clamp assembly 124 may be configured to create an electrically conductive path (e.g., a bond path as described herein) from solar panel 10, through clamp assembly 124 and to tall base 110. Clamp 126 may be stainless steel. Clamp 126 may also comprise one or more pins 135. In this regard, pin 135 may be configured to create an electrically conductive path between solar panel 10 and clamp assembly 124.

In various embodiments, clamp assembly 124 may be configured to retain solar panel 10 on tall base 110 at an angle θ. θ may likely be between approximately 7 degrees to 25 degrees. More particularly, θ may be 10 degrees, 15 degrees, 20 degrees, and/or the like.

In various embodiments, spacer 138 may be installed on tall base 110. Spacer 138 may provide flexibility for installation of an array around roof structures (e.g., vents, chimneys, antennas, and/or the like). Spacer 138 may also allow a user to adjust the installation angle of a solar panel.

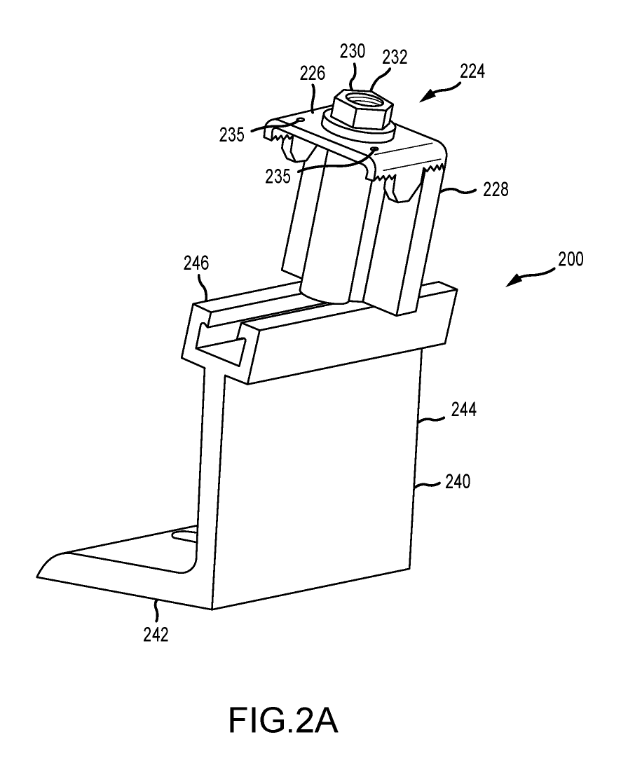

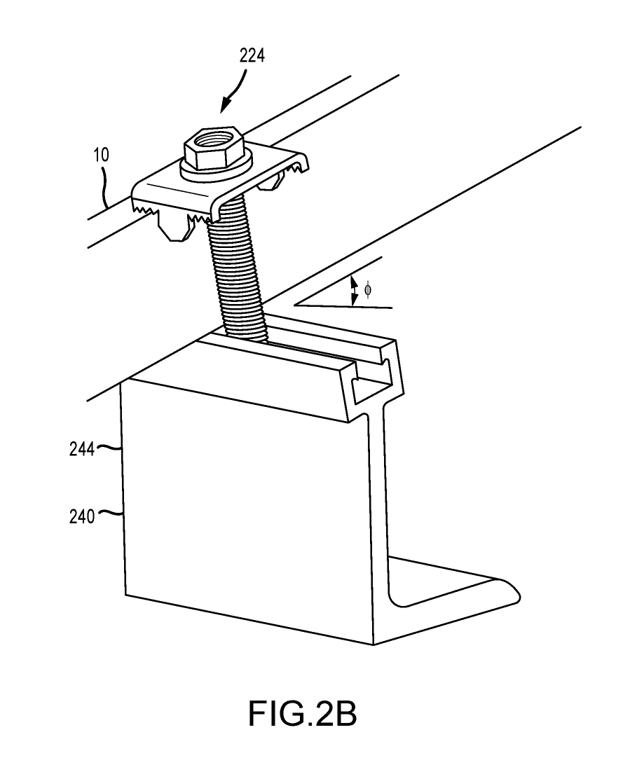

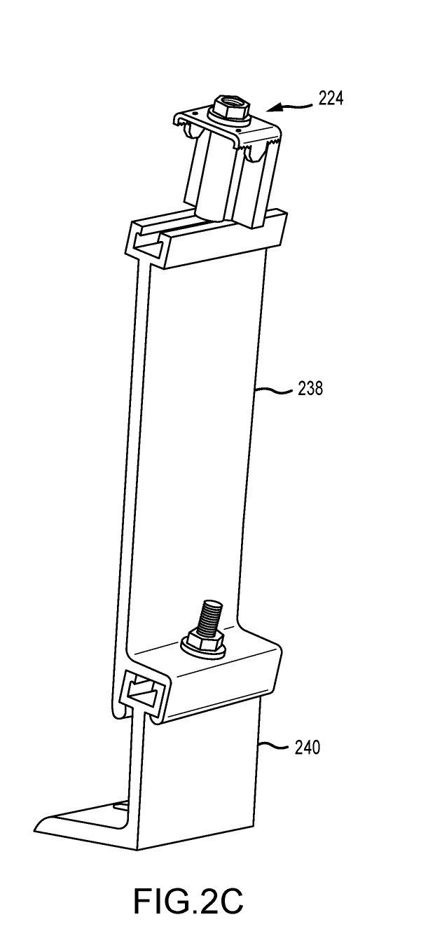

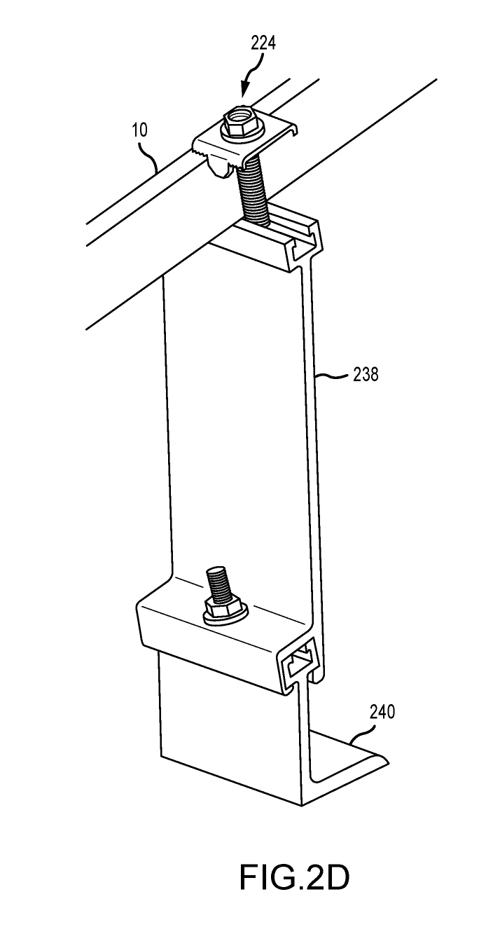

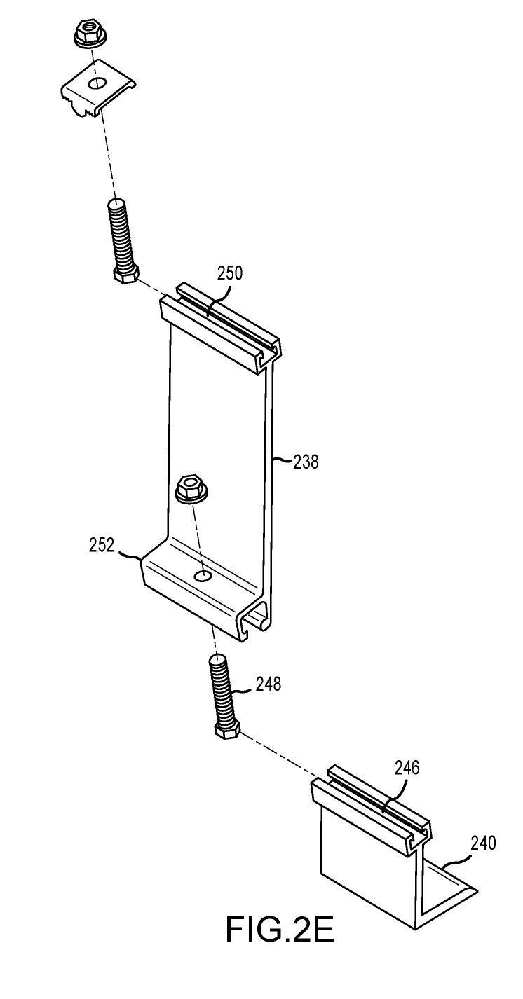

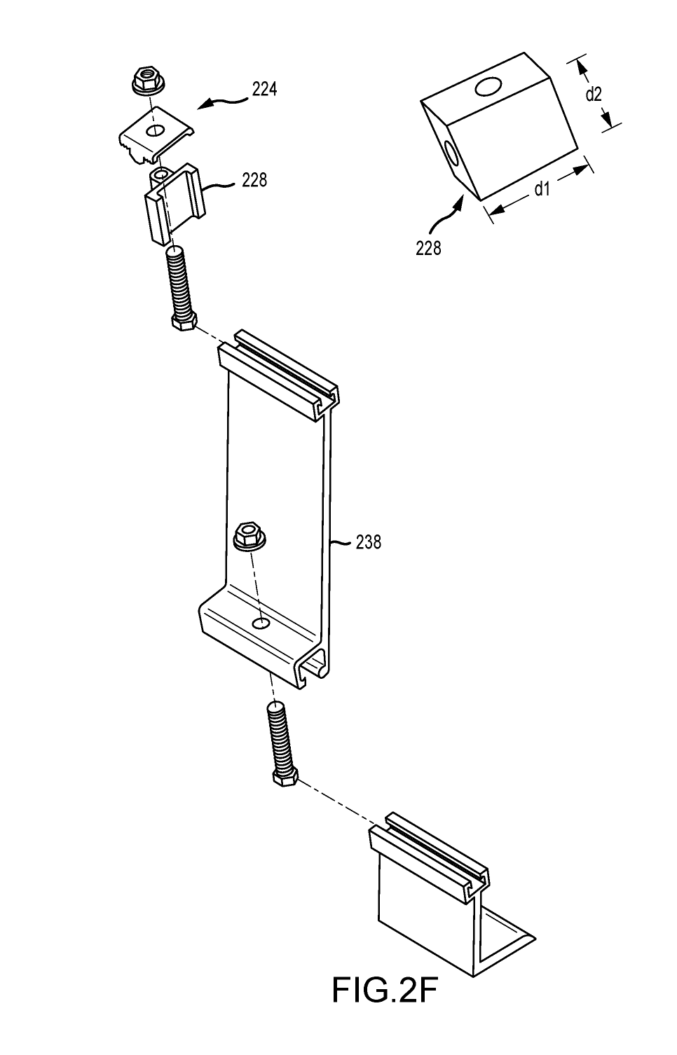

In various embodiments and with reference to FIGS. 2A-2F, solar panel support system 200 may comprise a short base 240. Short base 240 may comprise a foot 242, a body 244, and an attachment point 246 (e.g., a slot). In this regard, the attachment point 246 of short base 240 may be substantially similar to attachment point 114 of tall base 110. System 200 may also comprise clamp assembly 224. Clamp assembly 224 may include clamp 226, fastener 230, and nut 232. Clamp assembly 224 may also include spacer block 228. Clamp 226 may include one or more pins 233. Clamp 226 may also be made of stainless steel. As discussed herein, claim 226 and/or clamp assembly 224 may be configured to create an electrically conductive path (e.g., a bond path) between the solar panel and short base 240. Moreover, clamp assembly 224 may be used with tall base 110 or short base 240, as described herein.

In various embodiments and as described herein, short base 240 may be configured to mount one or more solar panels at an angle θ. θ may likely be between approximately 7 degrees to 25 degrees. More particularly, θ may be 10 degrees, 15 degrees, 20 degrees, and/or the like.

In various embodiments, spacer 238 may be configured to attached to short base 280. Moreover, multiple spacers 238 may be installed on one another to achieve a desired installation height.

In various embodiments, spacer block 228 may be installed with clamp assembly 224. As discussed herein, spacer block 228 may be installed at the end of an array to replicate the frame of a solar panel. Spacer block 228 may be a square or a rectangle. Spacer block 228 may include one or more hole allow for variable installation. Spacer 228 may also be a nonuniform shape that is installable on a fastener to space and support clamp 226.

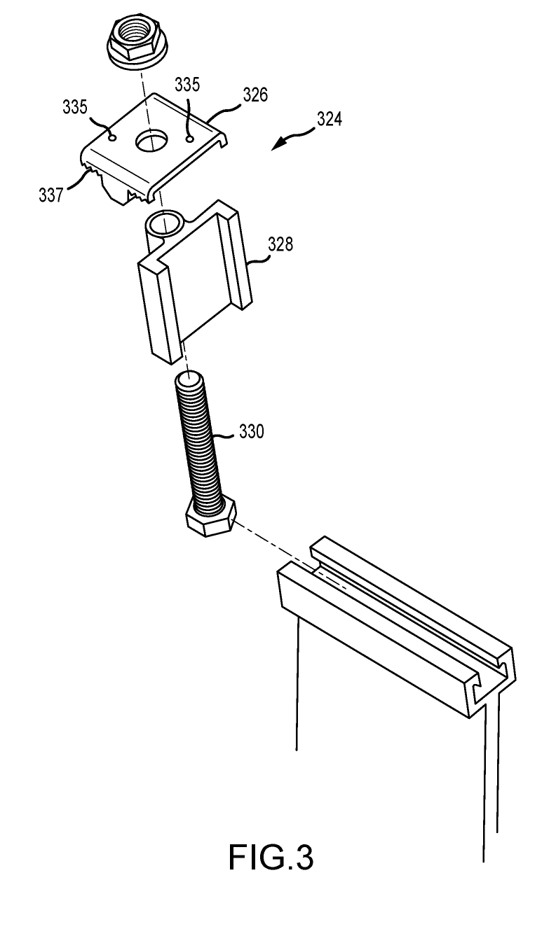

In various embodiments and with reference to FIG. 3, clamp 326 may be aluminum, or a composite material. Claim 326 may include one of more conductive elements 335 (e.g., pins). Clamp 236 may also be stainless steel. In this regard, clamp 326 may be configured to carry and/or transfer electricity to other components. Clamp 326 may be part of an electrically conductive path (e.g., bond path) that electrically links all portions and/or components of the solar support system described herein. Clamp 326 may include one or more teeth or serrations 337. Tooth 337 may be configured to engage or bite into the frame of a solar panel.

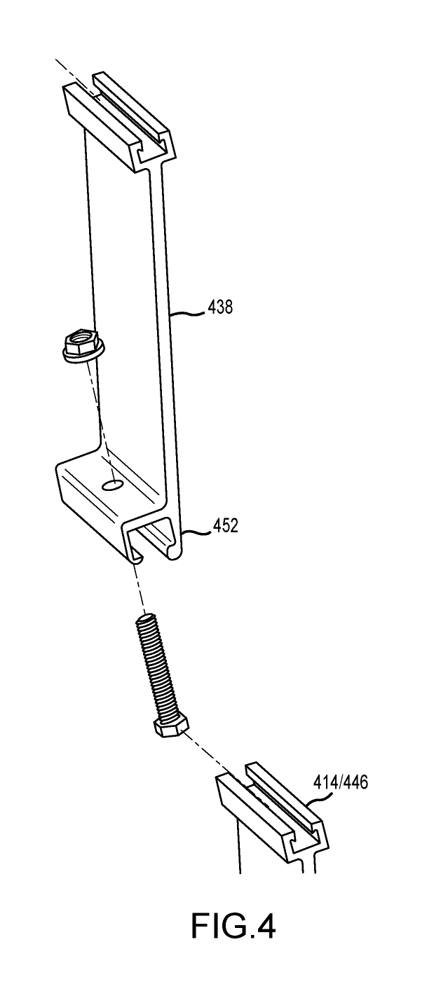

In various embodiments and with reference to FIG. 4, spacer 438 may include an attachment point 452 (e.g., a channel). Attachment point 452 may be configured to operatively couple to attachment point 114 of tall base 110. Attachment point 452 may also be configured to operatively couple to attachment point 246 of short base 240.

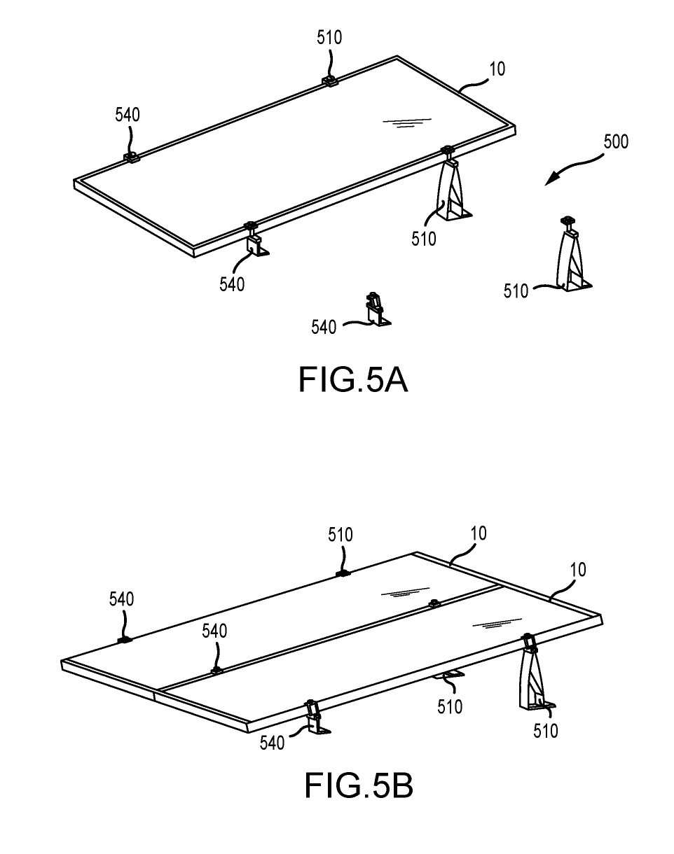

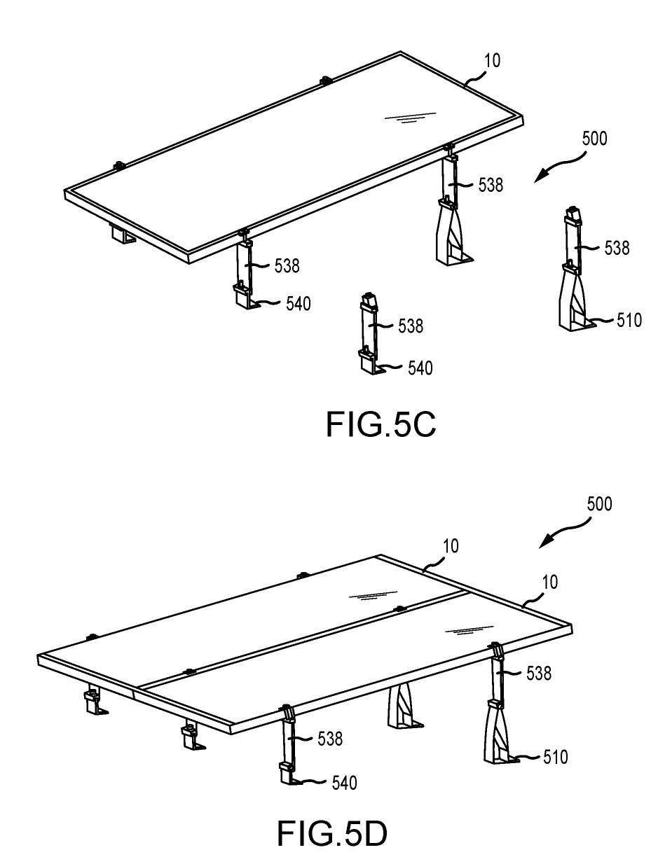

In various embodiments and with reference to FIGS. 5A-5D, system 500 may be configured as a rail free solar panel mounting system. In this regard, the system may be laid out with a plurality of tall brackets 510 and short brackets 540. Two solar panels 10 may be mounted on each tall bracket 510 and short bracket 540. Panels 10 may be retained on tall bracket 510 and short bracket 540 with the clamp assemblies described herein. Moreover, the system may include an electrically conductive path (e.g., a bond path) that electrically links each of the components together as discussed herein. Moreover, system 500 may be height adjustable. In this regard, each of the tall brackets 510 and short brackets 540 may be operatively coupled to one or more spacers 538.

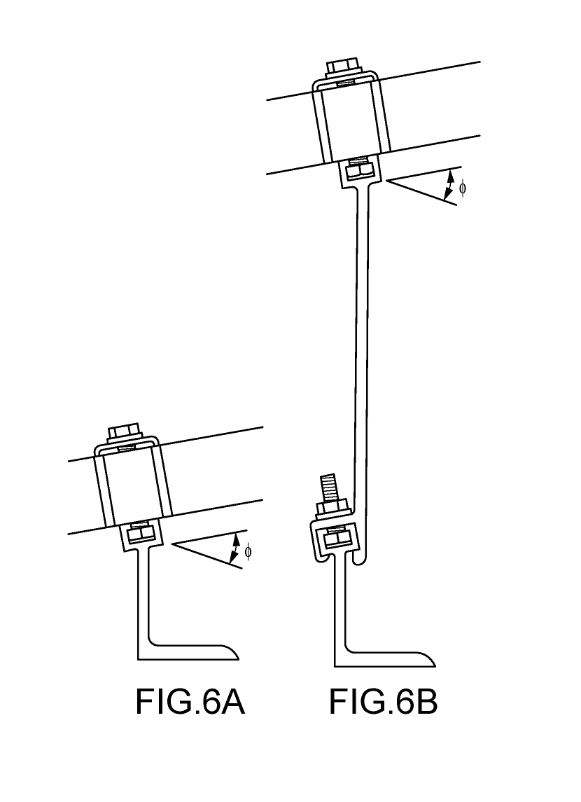

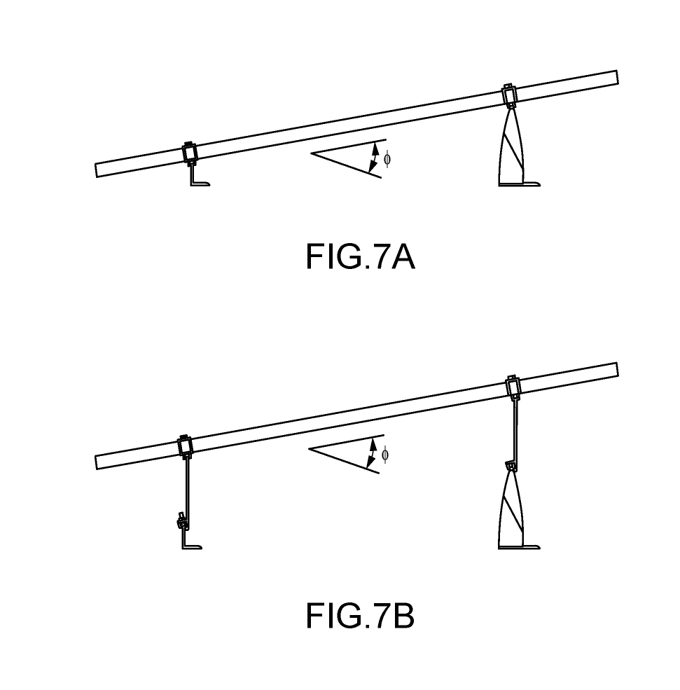

In various embodiments and with reference to FIGS. 6A-6B and 7A-7B, the spacers described herein may be configured to define an installation angle θ. That installation angle θ, may be the same as the installation angle, when a panel is attached to the tall base or short base as discussed herein. While the spacer may provide the same angle, the spacers allow for additional height for installed modules.

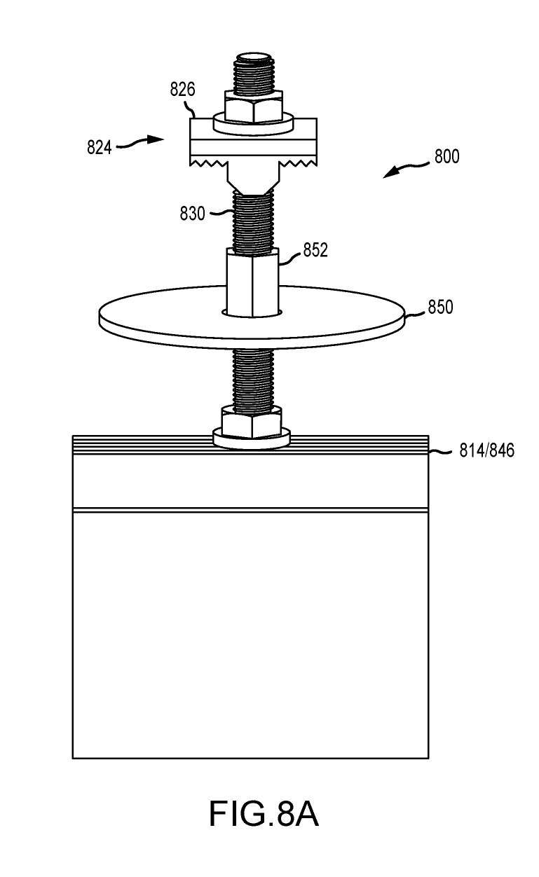

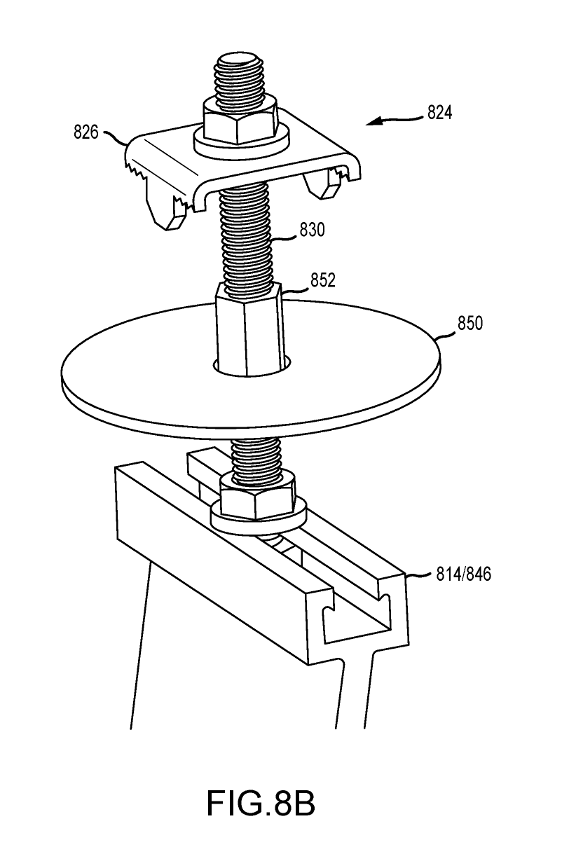

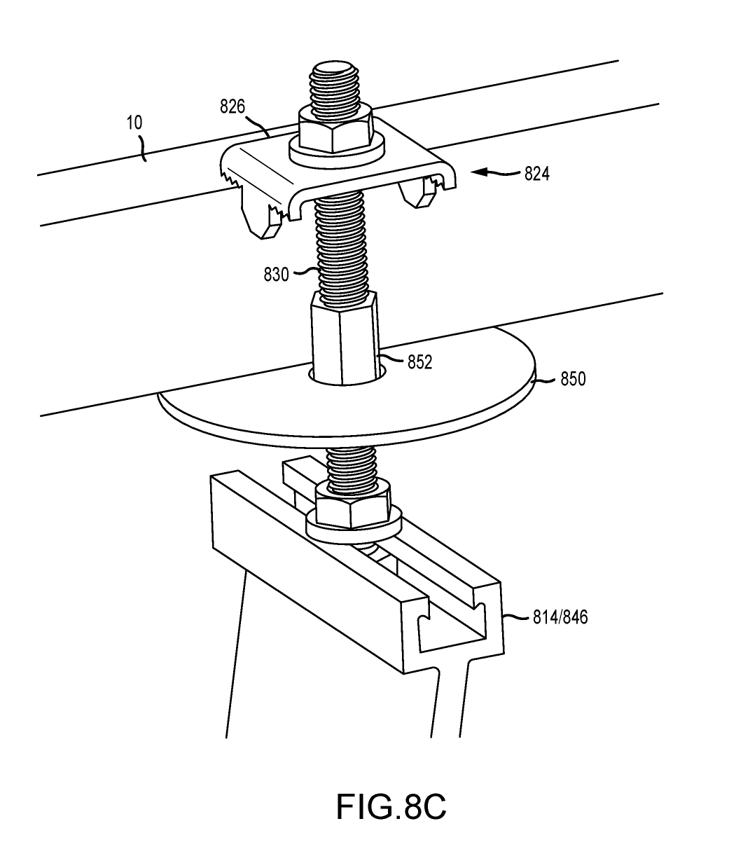

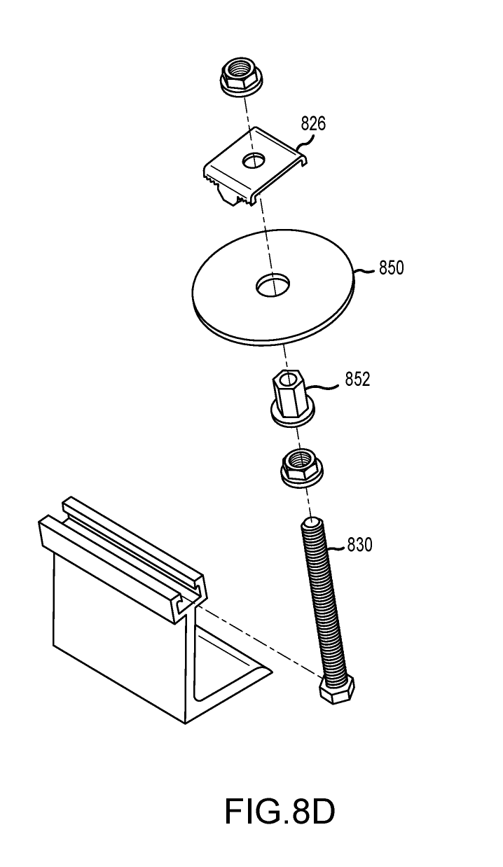

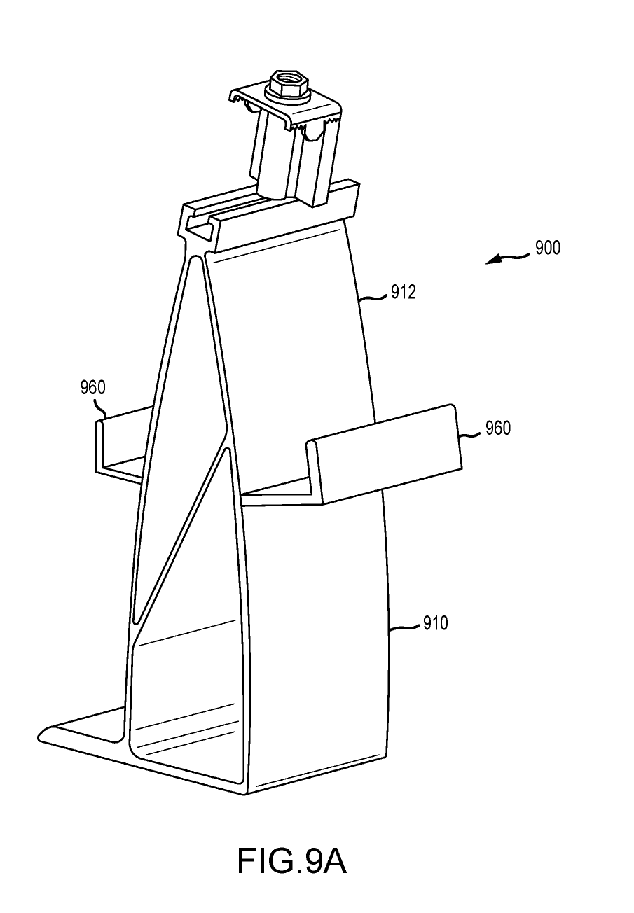

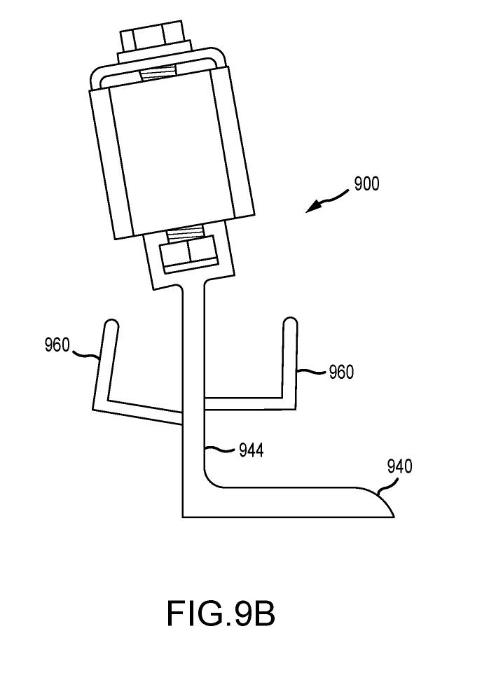

In various embodiments and with reference to FIGS. 8A-8D, system 800 may include a leveling assembly. The leveling assembly may be a portion of claim assembly 824. The leveling assembly may be installable on either the tall base or the short based as discussed herein. Moreover, the leveling assembly may be configured to change the angle or orientation of the panels when the panels are installed on system 800. In this regard, the leveling assembly may be configured to adjust the angle of the panel when installed.

In various embodiments, the leveling assembly may include a plate 850 and a leveling element 852 (e.g., a level nut). Leveling element 852 may be integrally formed in plate 850. Plate 850 may also include a hole and may be installed over leveling element 852. In operation, plate 850 may be movable up and down along fastener 830 in response to leveling element 852 being actuated.

In various embodiments, system 900 may include a wire management system. The wire management system may be configured to support and/or carry various wires and/or cables connecting one or more solar panels to one another. In this regard, tall base 910 and/or short base 940 may include one or more hooks 960. Hook 960 may be integrally formed in body 912 or body 944. Hook 960 may also be operatively coupled to body 912 or body 944. Hook 960 may include one or more attachment points (e.g., a hole, a standoff, and/or the like) that can be used to secure wires to hook 960.

In various embodiments, the systems described herein may be used with any suitable roof mounted structure including, for example, a solar panel array or system, an environmental conditioning system (e.g., HVAC, swamp cooler, and/or the like), a water system (e.g., a solar water heater, a water storage system, and/or the like). The systems may also be used with any suitable concrete or ceramic tile system. In this regard, the systems described herein provide a universal, watertight flashing system for tile style roofs.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A roof mounting system, comprising:
a short base having a first body and a first slot,
wherein the first slot is formed on the first body at an angle;
a tall base having a second body and a second slot,
wherein the second slot is formed on the second body at the angle;
a first clamp assembly configured to operatively couple to the first slot;
a second clamp assembly configured to operatively couple to the second slot,
wherein the first clamp and the second clamp are configured to engage and retain a solar panel on the short base and the tall base at the angle.

2. The mounting system of claim 1, further comprising:
a support fastener installable in the first slot or the second slot and configured to support at least one of the first clamp or the second clamp.

3. The mounting system of claim 1,
wherein the first clamp assembly comprises a threaded shaft that is installable in the first slot, and
wherein the first clamp assembly includes a level nut and a support plate that are adjustably installable on the threaded shaft and configured to support a solar panel.

4. The mounting system of claim 1, wherein the first clamp assembly comprises a spacer block that is configured to support a clamp.

5. The mounting system of claim 1,
wherein first clamp assembly comprises a clamp, and
wherein the clamp is configured with at least one of a pin and a tooth.

6. The mounting system of claim 5, wherein the at least one of the pin or the tooth is configured to create an electrically conductive path between the clamp and the solar panel.

7. The mounting system of claim 5, wherein the clamp has the tooth in response to being made of stainless steel.

8. The mounting system of claim 5, wherein the clamp has the pin in response to being made of aluminum.

9. The mounting system of claim 1, further comprising a spacer that is configured to mount to at least one of the first slot and the second slot.

10. The mounting system of claim 1, wherein the second body includes a cross support.

11. The mounting system of claim 10,
wherein the second body defines a first hollow and a second hollow, and
wherein the cross support is disposed between the first hollow and the second hollow.
